(19) United States
(12) Patent Application Publication
(10) Pub. No.: US 2025/0079496 A1
(43) Pub. Date: Mar. 6, 2025

(54) MANUFACTURING APPARATUS AND MANUFACTURING METHOD OF ALL-SOLID-STATE BATTERY CELL

(71) Applicant: HONDA MOTOR CO., LTD., Tokyo (JP)

(72) Inventor: Hanako Sawase, Wako-shi (JP)

(21) Appl. No.: 18/783,697

(22) Filed: Jul. 25, 2024

(30) Foreign Application Priority Data
Aug. 30, 2023 (JP) 2023-139585

(51) Int. Cl. H01M 10/04; H01M 10/0585

(52) U.S. Cl. CPC H01M 10/0404; H01M 10/0481; H01M 10/0585

(57) ABSTRACT

A manufacturing apparatus of an all-solid-state battery cell using a press machine includes: an electrode guide having a cylindrical shape and covering a sample, wherein at least part of the electrode guide in a circumferential direction is a division body which is a separate body from a remaining portion of the electrode guide, and the division body is attachable to and detachable from the remaining portion before and after pressing. In a manufacturing method of the all-solid-state battery cell, pressing to the solid-state battery cell is performed in a plurality of stages, and the division body is attached to and detached from the remaining portion at each time of pressing.

### CROSS-REFERENCE TO RELATED APPLICATION

Priority is claimed on Japanese Patent Application No. 2023-139585, filed on Aug. 30, 2023, the contents of which are incorporated herein by reference.

### BACKGROUND

### Field of the Invention

The present invention relates to a manufacturing apparatus and a manufacturing method of an all-solid-state battery cell.

### Background

Establishment of a triode cell of an all-solid-state lithium-ion battery is a challenge toward practical use. As an all-solid-state three-electrode cell including a reference electrode, a cell is described, for example, in Japanese Unexamined Patent Application, First Publication No. 2022-007408. The cell having a shape used in the related art has a structure in which an electrode guide portion is divided in a horizontal direction in advance and has a style in which at the cell fabrication, a solid electrolyte is injected in two stages, and a reference electrode is arranged therebetween. The electrode guide has a cylindrical shape of a tough material such as zirconia or alumina in order to ensure a strength that can withstand a molding pressure of about 1000 MPa.

### SUMMARY

In the related art described above, since a pressure of about 1000 MPa at the maximum is applied from an inner powder at the time of powder compacting, there is a possibility that deviation occurs between divided electrode guides, the powder leaks, or unevenness occurs in the applied pressure.

Further, when the powder compacting molding is performed once, since the cross section of an inner sample cannot be accessed, it is difficult to insert the reference electrode, and it is impossible to confirm whether or not the reference electrode maintains the aimed position without kinking or the like after the powder compacting molding. Therefore, since the performance of the cell containing the reference electrode cannot be determined without performing an electrochemical measurement, the rework is increased when the cell fails.

Further, since an electrode guide (zirconia, alumina, or the like) that requires strength is made of a non-transparent material, it is impossible to visually confirm a position where the reference electrode can be inserted. Further, since the electrode guide such as zirconia has a low transmittivity of X-ray, it is impossible to view an inner state by a non-destructive method by the CT or the like.

An aspect of the present invention provides a manufacturing apparatus and a manufacturing method of an all-solid-state battery cell capable of easily confirming a work at the time of powder pressing when manufacturing a cell.

A first aspect of the present invention is a manufacturing apparatus of an all-solid-state battery cell using a press machine, including: an electrode guide having a cylindrical shape and covering a sample, wherein at least part of the electrode guide in a circumferential direction is a division body which is a separate body from a remaining portion of the electrode guide, and the division body is attachable to and detachable from the remaining portion before and after pressing.

According to this configuration, by the division body of the electrode guide being attachable and detachable before and after the pressing, before the pressing, the division body is attached to form the electrode guide having a cylindrical shape and functions as an outer wall at the time of pressing, and after the pressing, it is possible to remove the division body and confirm whether the sample is normally laminated.

By the electrode guide being a division structure, it is possible to easily remove even a press body of a sample that is difficult to peel off due to adhesion.

It becomes possible to insert the reference electrode into the press body from an open portion when removing the division body and perform a measurement for confirming electric conduction, and it is also possible to shorten a manufacturing time and perform pressing by attaching the division body again. Further, when the press is performed a plurality of times by changing the press pressure, an additional sample can be easily added.

A second aspect of the present invention is the manufacturing apparatus of an all-solid-state battery cell according to the first aspect described above, wherein a joint portion between the division body and the remaining portion may be an irregularity fit portion having an irregularity that is fitted to each other.

According to this configuration, since the joint portion between the division body and the remaining portion is the irregularity fit portion, the division body is less likely to be peeled off, and the pressing of the sample can be performed while preventing position deviation of the division body.

For example, in the case of a halved electrode guide (made of zirconia), deviation may occur if positioning is not performed at an outer circumferential portion, but by including the irregularity fit portion at the joint portion, it is possible to prevent the position deviation of the division body.

A third aspect of the present invention is the manufacturing apparatus of an all-solid-state battery cell according to the first aspect described above, wherein in the electrode guide, a range of less than a half circumference in the circumferential direction from which a press body of the sample is capable of being removed may be the division body.

According to this configuration, as compared with the case where the electrode guide is halved, it is possible to set a minimum open portion from which the press body of the sample can be removed while causing the open portion of the electrode guide to be small by narrowing the range of the division body.

A fourth aspect of the present invention is the manufacturing apparatus of an all-solid-state battery cell according to the third aspect described above, wherein the remaining portion excluding the division body in the electrode guide may form an open portion having an opening width that is equal to or larger than the diameter of the press body of the sample.

According to this configuration, the remaining portion excluding the division body has an opening width that is equal to or larger than the diameter of the press body of the sample, and thereby, even when the range of less than the half circumference in the circumferential direction is the division body, it is possible to reliably remove the press body of the sample.

A fifth aspect of the present invention is the manufacturing apparatus of an all-solid-state battery cell according to any one of the first to fourth aspects described above, wherein the electrode guide may be formed of zirconia.

According to this configuration, by forming the electrode guide using the strong zirconia among ceramics, it is possible to form the electrode guide in which deformation is prevented and which also can withstand a pressure even in a division structure. A sixth aspect of the present invention is the manufacturing apparatus of an all-solid-state battery cell according to any one of the first to fifth aspects described above which may include: a restraint instrument that restrains the electrode guide from an outer circumferential side.

According to this configuration, by restraining the electrode guide in the division structure using the restraint instrument and performing pressing in this state, it is possible to withstand an internal pressure due to the pressing.

A seventh aspect of the present invention is a manufacturing method of an all-solid-state battery cell using a press machine, including: providing an electrode guide having a cylindrical shape and covering a sample: causing at least part of the electrode guide in a circumferential direction to be a division body which is a separate body from a remaining portion of the electrode guide; performing pressing to the solid-state battery cell in a plurality of stages; and attaching and detaching the division body to and from the remaining portion at each time of pressing.

According to this configuration, when performing the pressing in the plurality of stages in order to mold a press body such as a pressure bonding lithium, it is possible to confirm whether the sample is normally laminated by attaching and detaching the division body at each time of pressing, and it is possible to easily form a laminate body having a good quality.

An eighth aspect of the present invention is the manufacturing method of an all-solid-state battery cell according to the seventh aspect described above, which may include: forming a temporary shape by introducing the sample into the electrode guide and applying a pressure; and then inserting a reference electrode into the sample having the temporary shape.

According to this configuration, when the pressing is performed once, since it becomes possible to perform a management as a solid to some extent, by forming a solid electrolyte having a temporary shape in which the reference electrode can be easily inserted by weakening a pressing pressure, it is possible to facilitate manufacturing of the all-solid-state battery cell.

A ninth aspect of the present invention is the manufacturing method of an all-solid-state battery cell according to the seventh or eighth aspect described above which may include: covering the sample by a cover material made of a polyimide film at an inside of the electrode guide.

According to this configuration, it is possible to prevent another material from mixing at the inside of the electrode guide. The cover material can be formed of a material such as Kapton (registered trademark) which is generally distributed.

A tenth aspect of the present invention is the manufacturing method of an all-solid-state battery cell according to the ninth aspect described above which may include: peeling off the cover material made of the polyimide film by cutting; and exposing a press body.

According to this configuration, it is possible to simply expose and confirm the press body and easily insert the reference electrode.

An eleventh aspect of the present invention is the manufacturing method of an all-solid-state battery cell according to the ninth or tenth aspect described above which may include: pressing the sample introduced into the cover material in an axis direction in a state where the division body and the remaining portion of the electrode guide are restrained from an outer circumferential side.

According to this configuration, by pressing the sample in the cover material in the state where the electrode guide in the division structure is restrained, it is possible to press the sample while withstanding an internal pressure due to the pressing.

According to the aspect of the present invention, it is possible to provide a manufacturing apparatus and a manufacturing method of an all-solid-state battery cell capable of easily confirming a work at the time of powder pressing when manufacturing a cell.

### BRIEF DESCRIPTION OF THE DRAWINGS

FIG. 1 is an explanatory view showing a first stage of an overall manufacturing flow of an all-solid-state battery cell in an embodiment of the present invention.

FIG. 2 is an explanatory view showing a second stage of the overall manufacturing flow.

FIG. 3 is an explanatory view showing a third stage of the overall manufacturing flow.

FIG. 4 is an explanatory view showing a fourth stage of the overall manufacturing flow.

FIG. 5A is a horizontal cross-sectional view of a sample position of FIG. 4.

FIG. 5B is a horizontal cross-sectional view showing a first modification example of an electrode guide and is a horizontal cross-sectional view of a sample position of FIG. 4.

FIG. 5C is a horizontal cross-sectional view showing a second modification example of an electrode guide and is a horizontal cross-sectional view of a sample position of FIG. 4.

FIG. 6 is an explanatory view showing a first detail at the time of manufacturing of the all-solid-state battery cell in the embodiment of the present invention.

FIG. 7 is an explanatory view showing a second detail at the time of manufacturing.

FIG. 8 is an explanatory view showing a third detail at the time of manufacturing.

FIG. 9 is an explanatory view showing a fourth detail at the time of manufacturing.

FIG. 10 is an explanatory view showing a fifth detail at the time of manufacturing.

FIG. 11 is an explanatory view showing a sixth detail at the time of manufacturing.

FIG. 12 is an explanatory view showing a seventh detail at the time of manufacturing.

### DESCRIPTION OF EMBODIMENTS

Hereinafter, embodiments of the present invention will be described with reference to the drawings.

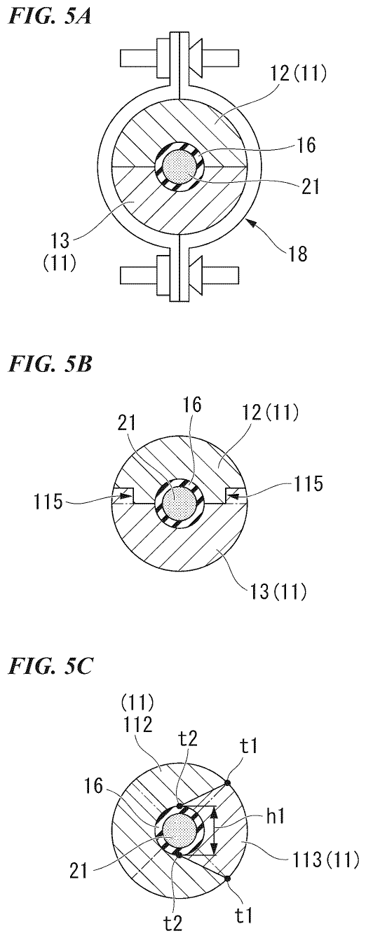

With reference to FIG. 4 and FIG. 5A to 5C, in a manufacturing apparatus 1 and a manufacturing method of an all-solid-state battery cell 23 in the present embodiment, by causing an electrode guide 11 when manufacturing an all-solid-state battery cell (basic evaluation cell) 23 to be a division shape in a vertical direction, since it becomes possible to remove the electrode guide 11 even after a pellet is fabricated, and a pellet cross section can be exposed, it becomes possible to insert a reference electrode 22. Further, by inserting a Kapton (registered trademark) tube between the electrode guide 11 and short and long axes 5, 9 of power collection blocks 3, 7 of the manufacturing apparatus 1, a structure is maintained even if a zirconia tube (electrode guide 11) is removed after the pellet is fabricated, and it is possible to visually observe an internal state and confirm a position where the reference electrode 22 can be inserted.

Further, by inserting a polyimide tube between the electrode guide 11 and the short and long axes 5, 9 of a power collection guide that presses the basic evaluation cell 23, since the zirconia tube can be moved upward and downward, it is possible to perform positioning of the position where the reference electrode 22 can be inserted.

Further, by causing the electrode guide 11 of the basic evaluation cell 23 to be a division shape and be restrained by a restraint instrument 18, it is possible to realize a strength that can withstand a pressure of about 1000 MPa.

Further, by causing the electrode guide 11 through which an X-ray does not transmit to be removable without an operation of the power collection blocks 3, 7, it is possible to perform a radiation light measurement by a non-destructive method, In situ measurement at each fabrication stage, or the like.

Hereinafter, the manufacturing apparatus 1 and the manufacturing method of the all-solid-state battery cell 23 is described.

As shown in FIG. 4, the manufacturing apparatus 1 includes a first tool (short axis power collection block 3) that is fixed to a movable mold of a press machine and a second tool (long axis power collection block 7) that is fixed to a fixation mold of the press machine. In FIG. 4, the movable mold is arranged at an upper side, the fixation mold is arranged at a lower side, and an upward-downward direction in the drawing becomes a pressing direction.

With reference also to FIG. 5A, the short axis power collection block 3 includes a first protrusion portion (short axis protrusion portion 5) that has a column shape and is inserted into a cover material 16 having a cylindrical shape from an axis direction one end side. In the short axis power collection block 3, the short axis protrusion portion 5 protrudes downward from a substantially horizontal base portion 4.

The long axis power collection block 7 includes a second protrusion portion (long axis protrusion portion 9) that has a column shape and is inserted into the cover material 16 having a cylindrical shape from an axis direction another end side. In the long axis power collection block 7, the long axis protrusion portion 9 protrudes upward from a substantially horizontal base portion 8.

The short axis protrusion portion 5 is shorter than the long axis protrusion portion 9 in the pressing direction. A front end surface of the short axis protrusion portion 5 and a front end surface of the long axis protrusion portion 9 face each other in the pressing direction in the cover material 16.

The cover material 16 is a member which has a cylindrical shape and in which an axis direction is directed in the pressing direction. The cover material 16 is attachably and detachably arranged on an inner circumferential side of the electrode guide 11 and covers a sample 21. The cover material 16 is formed by winding a polyimide film such as Kapton (registered trademark) which is generally distributed in a cylindrical shape. The cover material 16 has an inner circumferential surface that is matched to an outer circumferential surface of the short and long axis protrusion portions 5, 9.

The electrode guide 11 is a member that has a cylindrical shape, is arranged on an outer circumferential side of the cover material 16, covers the cover material 16, and receives an internal pressure caused by pressing the sample 21. The electrode guide 11 is a member that has a cylindrical shape, is arranged coaxially with the cover material 16, and has a thickness larger than that of the cover material 16. The electrode guide 11 has an inner circumferential surface that is matched with an outer circumferential surface of the cover material 16 into which the short and long axis protrusion portions 5, 9 are inserted. For example, the electrode guide 11 is formed of zirconia, and the strength is ensured.

When the electrode guide 11 is formed of zirconia, the electrode guide 11 alone can ensure a strength that withstands the internal pressure due to the pressing, but when including the restraint instrument 18 that restrains the electrode guide 11, the electrode guide 11 may be formed of a material (Macor (registered trademark), alumina, or the like) having a strength lower than that of zirconia.

For example, the electrode guide 11 is divided into a pair of half division bodies 12, 13 along the axis direction. The electrode guide 11 is attached to a target object such as the cover material 16 such that the pair of half division bodies 12, 13 sandwich the target object from a radial direction.

In FIG. 5A, at a joint portion of the pair of half division bodies 12, 13, flat surfaces along the radial direction are in contact with each other.

On the other hand, for example, as shown in FIG. 5B, the joint portion of the pair of half division bodies 12, 13 may be a irregularity fit portion 115 having an irregularity. In this case, position deviation between the half division bodies 12, 13 is less likely to occur, the half division bodies 12, 13 are less likely to be peeled off from each other, and the pressing of the sample 21 can be favorably performed. By using a strong electrode guide 11, the sample 21 and the cover material 16 are prevented from expanding to the outer circumferential side when applying a pressure to the sample 21, and a press body having a uniform diameter is formed.

One of the pair of half division bodies 12, 13 can also be regarded as a division body which is a separate body from the other of the pair of half division bodies 12, 13. In this case, the division body is formed in a range of a half circumference in the circumferential direction of the electrode guide 11.

On the other hand, for example, as shown in FIG. 5C, a range of about ¼ in the circumferential direction of the electrode guide 11 may be a division body 113, and the division body 113 may be attachable to and detachable from a remaining portion 112. In this case, the range in which the division body 113 is provided may be a minimum range from which the press body of the sample 21 can be removed.

In the embodiment, the size (the size of an open portion of the electrode guide 11) of the division body 113 is on the basis of a circumference length of an outer circumferential surface of the electrode guide 11. The phrase “a range of about ¼ in the circumferential direction of the electrode guide 11 is a division body 113” refers to a configuration in which the division body 113 is cut out by using a straight line (or a tangent line extending to the inner circumferential surface) extending from both ends t1 of an arc that is ¼ of the outer circumferential surface of the electrode guide 11 to both ends t2 of an arc that is ½ of the inner circumferential surface of the electrode guide 11 as a division line in a cross-sectional view in FIG. 5C. At this time, the remaining portion 112 excluding the division body 113 forms an open portion having an opening width h1 (equal to or larger than the diameter of the press body having a column shape formed in the electrode guide 11) that is equal to or larger than the diameter of the inner circumferential surface of the electrode guide 11. Thereby, even when a range of less than a half circumference in the circumferential direction of the electrode guide 11 is the division body 113, it becomes possible to remove the press body of the sample 21.

That is, at least part of the electrode guide 11 in the circumferential direction is a division body which is a separate body from the remaining portion of the electrode guide 11, and by attaching and detaching the division body to and from the remaining portion before and after the pressing, an open portion from which the press body of the sample 21 can be removed is formed.

The embodiment is described using an example in which the range of a ½ circumference or a ¼ circumference of the electrode guide 11 is the division body 11; however, the embodiment is not limited to this configuration. For example, the division body may be downsized to about a ⅛ circumference of the electrode guide 11 (here, it is required to withstand an internal pressure of pressing). Also in this case, the open portion of the remaining portion 112 ensures an opening width h1 that is equal to or larger than the diameter of the inner circumferential surface of the electrode guide 11. Further, the embodiment is not limited to a configuration in which the electrode guide 11 is divided into two portions in the circumferential direction, and a configuration may be employed in which the electrode guide 11 is divided into three or more portions in the circumferential direction. In this case, if the circumference length of the inner circumferential surface of each division body is less than a ½ circumference of the electrode guide 11, it is possible to remove the press body of the sample 21.

First, a general flow when manufacturing the all-solid-state battery cell (basic evaluation cell) 23 is described.

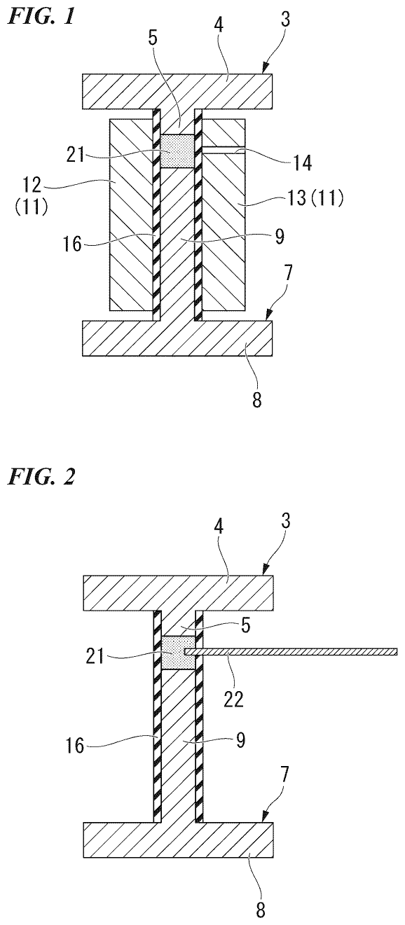

FIG. 1 shows a state in which the sample 21 (SE (solid electrolyte)) in a powder is sandwiched between the short axis protrusion portion 5 and the long axis protrusion portion 9, the outer circumference of the sample 21, the short axis protrusion portion 5, and the long axis protrusion portion 9 are covered by the cover material 16, and the outer circumference of the cover material 16 is covered by the electrode guide 11. In this state, a load of about a human power is applied in the pressing direction to the short axis power collection block 3 and the long axis power collection block 7 without using a press machine, and a pressure is applied to such an extent that the sample 21 is solidified in a temporary shape.

Then, as shown in FIG. 2, the electrode guide 11 is removed, and the position in a semitransparent cover material 16 where the sample 21 is covered is visually confirmed. Then, the position in the cover material 16 where the sample 21 is covered is slit by a cutter or the like, and the reference electrode 22 is inserted in a radial direction. Since the sample 21 is in a solidified state with a light load, insertion of the reference electrode 22 is easy. The gap between the electrode guide 11 and the reference electrode 22 is sealed by an insulating material putty, an epoxy resin bond, a dental cement, or the like. By causing the reference electrode 22 not to move, it is possible to prevent generation of an unexpected potential change or the like.

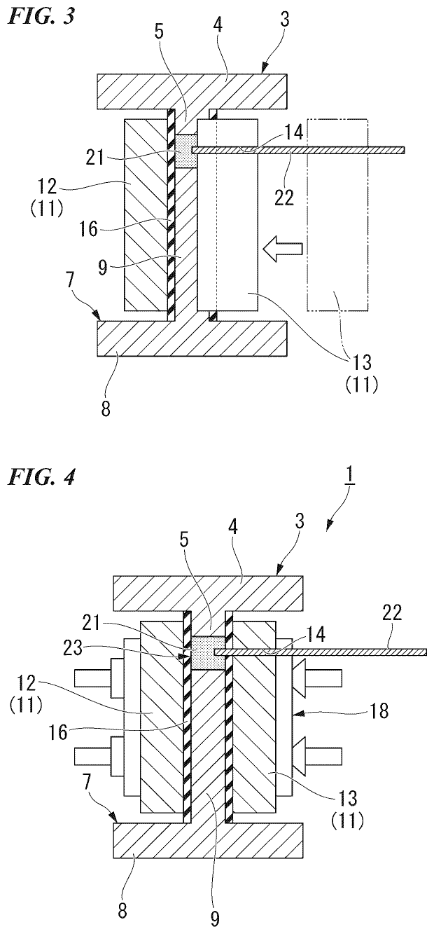

Then, as shown in FIG. 3 and FIG. 4, the electrode guide 11 is attached again, a reference instrument made of a metal is attached to the electrode guide 11, and the electrode guide 11 is fixed in a cylindrical form. A penetration hole 14 through which a wiring side of the reference electrode 22 is inserted is formed on one half division body 13 of the electrode guide 11. In this state, the short axis power collection block 3 and the long axis power collection block 7 are attached to the movable mold and the fixation mold of the press machine, and pressing is performed by the press machine at a predetermined pressure.

Next, manufacturing of the all-solid-state battery cell (basic evaluation cell) 23 in the embodiment is described in more detail.

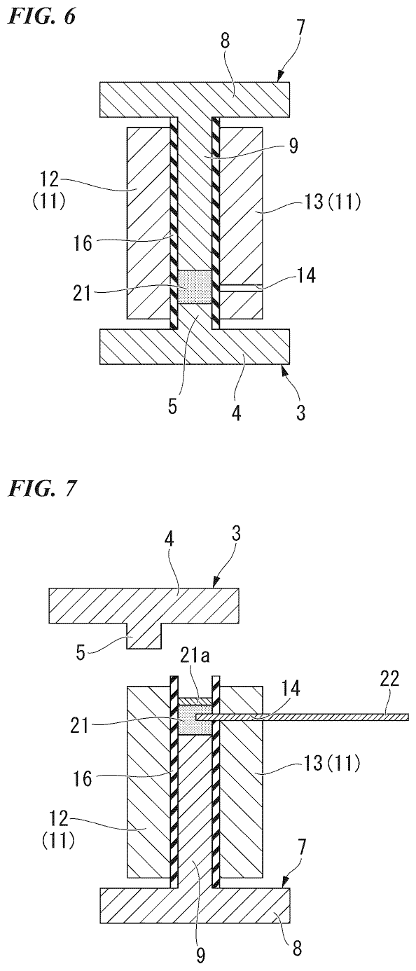

In the embodiment, as shown in FIG. 6, the short axis power collection block 3 is placed upside down, and the short axis protrusion portion 5 is covered with the cover material 16 (polyimide tube) from above. The sample 21 (SE powder) in a powder is placed in the cover material 16, and the sample 21 is deposited on a front end of the short axis protrusion portion 5. Then, the long axis protrusion portion 9 of the long axis power collection block 7 is inserted into the cover material 16 from above, and the sample 21 is sandwiched between the short axis protrusion portion 5 and the long axis protrusion portion 9. At this time, the outer circumference of the cover material 16 is covered with the electrode guide 11. In this state, a load of about a human power is applied to the short axis power collection block 3 and the long axis power collection block 7, and a pressure is applied to such an extent that the sample 21 is solidified in a temporary shape. The hardness of the sample 21 is such that the powder does not fall even when the long axis protrusion portion 9 is removed from the cover material 16, and the cover material 16 is turned upside down.

Then, the electrode guide 11 is removed, and the sample 21 portion is visually confirmed from the polyimide tube (cover material 16) (refer to FIG. 2). Then, the sample 21 portion of the cover material 16 is slit by using a cutter or the like, and the reference electrode 22 is inserted in a radial direction. Alternatively, the reference electrode 22 may be arranged on the polyimide tube (cover material 16) in advance before injecting the sample 21, and then, the sample 21 may be injected. The inserted location may be closed by a polyimide tape or the like.

It is assumed that the reference electrode 22 here is a LTO, a LFP, or the like used in a general lithium-ion battery with which conduction is made by platinum, a Ni wire, or the like; however, the material or the structure is not particularly limited as long as a reference potential can be obtained with respect to the electrode, and the insulation property from the reference electrode 22 to a measurement device is maintained.

As shown in FIG. 7, any of the short axis protrusion portion 5 and the long axis protrusion portion 9 is removed at this stage, and a positive electrode 21a is arranged on the sample 21 having a temporary shape. In the embodiment, the short axis protrusion portion 5 is removed. The positive electrode 21a may be a dry type or a wet type, but when a power collection foil is arranged, the power collection foil is arranged not on the sample 21 side but on the power collection block side. In the embodiment, an example is shown in which the positive electrode 21a is arranged on the short axis protrusion portion 5 side. When the sample 21 or the like is introduced in the cover material 16, particularly when the sample 21 has a temporary shape in a sol or the like, the sample 21 is poured along the cover material 16.

As an effect of the configuration so far, first, by the electrode guide 11 being capable of being removed, it is possible to visually confirm the sample 21 position, and it becomes easy to confirm a position where the reference electrode 22 is inserted.

Further, an insertion state can be visually confirmed even after the reference electrode 22 is inserted. Further, by using the polyimide tube for the cover material 16, even if the cross section of the sample 21 is slit, the powder does not spill.

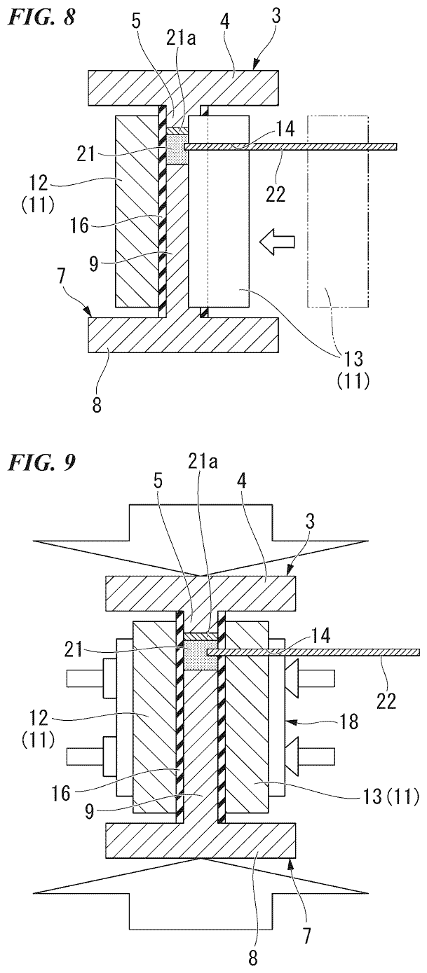

As shown in FIG. 8, a penetration hole 14 for inserting the reference electrode 22 is formed on one half division body 13 of the electrode guide 11. After the short axis protrusion portion 5 is inserted again into the cover material 16, the wiring side of the reference electrode 22 is inserted into the penetration hole 14 of the half division body 13, and the half division body 13 is caused to approach to come into contact with the cover material 16. The other half division body 12 is caused to come into contact with the cover material 16 from an opposite side. Thereby, the cover material 16, the short and long axis protrusion portions 5, 9 on the inner side of the cover material 16, and the sample 21 are sandwiched by the pair of half division bodies 12, 13. When there is a margin between the reference electrode 22 and the penetration hole 14 for inserting the reference electrode 22, the space is closed by using an epoxy resin bond, a dental cement, or the like. At this time, attention should be paid not to interfere with the reference electrode 22.

Then, as shown in FIG. 9, the restraint instrument 18 is attached to the electrode guide 11 and is fixed in a cylindrical form. In this state, the short axis power collection block 3 and the long axis power collection block 7 are attached to the movable mold and the fixation mold of the press machine, and the powder compacting molding pressing is performed by the press machine at a predetermined pressure (about 1000 MPa at the maximum).

In order to hold the electrode guide 11 at a position that does not interfere with the reference electrode 22, the electrode guide 11 is fixed by using a polyimide tape or the like. A penetration hole (not shown) for inserting the reference electrode 22 is formed also on the restraint instrument 18, and by inserting the reference electrode 22 into the penetration hole of the restraint instrument 18, the electrode guide 11 is restrained while paying attention such that interference does not occur. In this state, the powder compacting molding (about 1000 MPa at the maximum) is performed by the press machine.

As an effect of the configuration so far, first, by the electrode guide 11 being capable of being removed, it is possible to visually confirm a state of the reference electrode 22 in each stage of molding. Further, in addition to the electrode guide 11 being capable of being removed, by using the cover material 16 of the polyimide tube, while maintaining an atmosphere unexposed state, an in situ analysis or the like in the all-solid-state battery cell (basic evaluation cell) 23 can be performed.

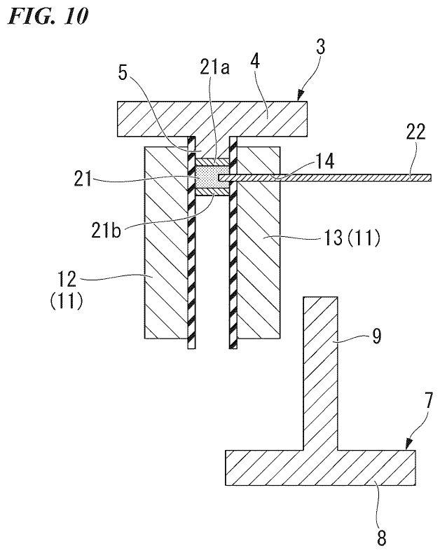

As shown in FIG. 10, after the powder compacting molding, the restraint instrument 18 is removed once, the power collection block on the opposite side of the positive electrode 21a is removed, and then a negative electrode 21b (Li or the like) is arranged on the sample 21. When a power collection foil is arranged, the power collection foil is arranged not on the sample 21 side but on the power collection block side. In order to hold the electrode guide 11 at a position that does not interfere with the reference electrode 22, the electrode guide 11 is fixed by using a polyimide tape or the like.

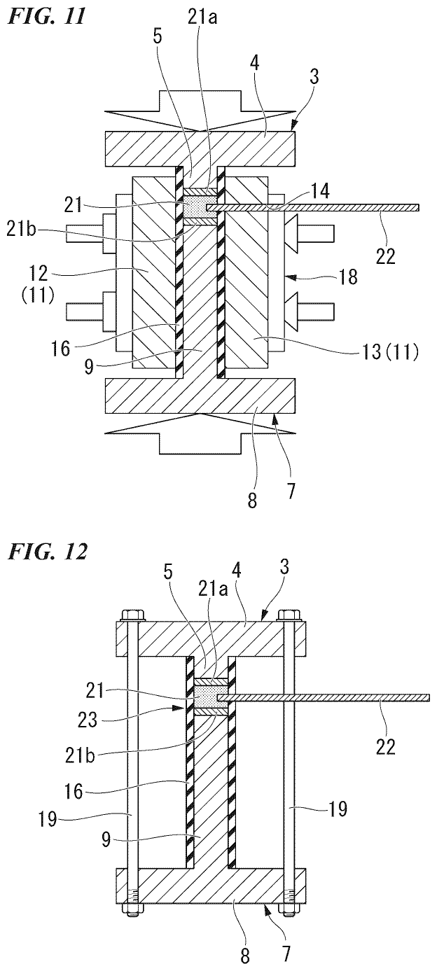

Then, as shown in FIG. 11, the reference electrode 22 is inserted into the penetration hole for inserting the reference electrode 22 formed in the restraint instrument 18, and the electrode guide 11 is restrained while paying attention such that interference does not occur. In this state, a pressure bonding press for joining the negative electrode 21b to the sample 21 is performed (about 150 MPa in the case of Li, the pressure is lower than that of the previous powder compacting molding pressing in the case of any material).

Then, as shown in FIG. 12, the restraint instrument 18 and the electrode guide 11 are removed. In order to maintain a restraint pressure (about 1 to 5 MPa) in the pressing direction of the manufactured all-solid-state battery cell (basic evaluation cell) 23, fastening between the power collection blocks 3, 7 is performed by using a bolt 19 or the like. Since the pressure at this time is much lower than that at the time of molding, when it can be confirmed that the shape of the sample is maintained, a restraint component and the electrode guide 11 may not be attached. Depending on the situation, only the electrode guide 11 may be attached.

As an effect of the configuration so far, first, by the electrode guide 11 being capable of being removed, it is possible to visually confirm a state of the reference electrode 22 in each stage of molding. Further, in addition to the electrode guide 11 being capable of being removed, by using the cover material 16 of the polyimide tube, while maintaining an atmosphere unexposed state, an in situ analysis or the like in the all-solid-state battery cell (basic evaluation cell) 23 can be performed.

In order to maintain the atmosphere unexposed state, after the pressing is completed, for example, both end portions of the cover material 16 are bonded and are sealed by a heat sealer. Alternatively, after the pressing is completed, for example, both end portions of the cover material 16 are adhered and are sealed by an epoxy resin. These seal methods may use the heat sealer for one side and an adhesive for the other side. If the cover material 16 has an extra length, the cover material 16 may be sealed by winding or twisting or may be sealed by using a tool such as a clip without performing the adhesion.

For example, an information description portion that describes specific information of the sample 21 may be provided on an outer surface of the cover material 16. Thereby, the sample 21 can be specified at a transportation destination. A paint or an ink used for printing or description on the information description portion shall be one through which the X-ray transmits. Thereby, it is possible to reduce the impact on the X-ray examination of the sample 21.

As described above, the configuration of the embodiment described above is a manufacturing apparatus 1 of an all-solid-state battery cell 23 using a press machine, including: an electrode guide 11 having a cylindrical shape and covering a sample 21; and a cover material 16 that is arranged between the electrode guide 11 and the sample 21, is attachable to and detachable from the electrode guide 11, and has a cylindrical shape.

According to this configuration, by covering the sample 21 using the cover material 16 having a cylindrical shape in the electrode guide 11, it is possible to easily remove even the sample 21 that is difficult to peel off due to adhesion. Since the sample 21 is accommodated in the cover material 16, a cleaning work of the electrode guide 11 is not required, the next work can be performed in a glove box, or the like, and thereby, it is possible to enhance the manufacturing efficiency. If the electrode guide 11 is removed, it is possible to confirm whether the sample 21 is normally laminated before and after pressing.

In the manufacturing apparatus 1 of the all-solid-state battery cell 23 described above, the cover material 16 is formed of a polyimide. Specifically, the cover material 16 is formed of a polyimide film.

According to this configuration, by forming the cover material 16 using polyimide, the effect on the X-ray examination of the press body in the cover material 16 is reduced, and it is possible to remove the press body from the electrode guide 11 without being exposed to the atmosphere. The cover material 16 can be formed of a material such as Kapton (registered trademark) which is generally distributed.

Further, the configuration of the embodiment is a manufacturing apparatus 1 of an all-solid-state battery cell 23 using a press machine, including: an electrode guide 11 having a cylindrical shape and covering a sample 21, wherein at least part (one of half division bodies 12, 13, a division body 113) of the electrode guide 11 in a circumferential direction is a division body which is a separate body from a remaining portion (the other of half division bodies 12, 13, a remaining portion 112) of the electrode guide 11, and the division body is attachable to and detachable from the remaining portion before and after pressing.

According to this configuration, by the division body of the electrode guide 11 being attachable and detachable before and after the pressing, before the pressing, the division body is attached to form the electrode guide 11 having a cylindrical shape and functions as an outer wall at the time of pressing, and after the pressing, it is possible to remove the division body and confirm whether the sample 21 is normally laminated.

By the electrode guide being a division structure, it is possible to easily remove even a press body of a sample 21 that is difficult to peel off due to adhesion.

It becomes possible to insert the reference electrode 22 into the press body from an open portion when removing the division body and perform a measurement for confirming electric conduction, and it is also possible to shorten a manufacturing time and perform pressing by attaching the division body again. Further, when the press is performed a plurality of times by changing the press pressure, an additional sample 21 can be easily added.

In the manufacturing apparatus 1 of the all-solid-state battery cell 23 described above, a joint portion between the division body and the remaining portion may be an irregularity fit portion 115 having an irregularity that is fitted to each other.

According to this configuration, since the joint portion between the division body and the remaining portion is the irregularity fit portion 115, the division body is less likely to be peeled off, and the pressing of the sample 21 can be performed while preventing position deviation of the division body. For example, in the case of a halved electrode guide 11 (made of zirconia), deviation may occur if positioning is not performed at an outer circumferential portion, but by including the irregularity fit portion 115 at the joint portion, it is possible to prevent the position deviation of the division body.

In the manufacturing apparatus 1 of the all-solid-state battery cell 23 described above, in the electrode guide 11, a range of less than a half circumference in the circumferential direction from which a press body of the sample 21 is capable of being removed may be the division body 113.

At this time, the remaining portion 112 excluding the division body 113 in the electrode guide 11 forms an open portion having an opening width h1 that is equal to or larger than the diameter of the press body of the sample 21.

According to this configuration, as compared with the case where the electrode guide 11 is halved, it is possible to set a minimum open portion from which the press body of the sample 21 can be removed while causing the open portion of the electrode guide 11 to be small by narrowing the range of the division body 113. The remaining portion 112 excluding the division body 113 has an opening width h1 that is equal to or larger than the diameter of the press body of the sample 21, and thereby, even when the range of less than the half circumference in the circumferential direction is the division body 113, it is possible to reliably remove the press body of the sample 21.

In the manufacturing apparatus 1 of the all-solid-state battery cell 23 described above, the electrode guide 11 may be formed of zirconia.

According to this configuration, by forming the electrode guide 11 using the strong zirconia among ceramics, it is possible to form the electrode guide 11 in which deformation is prevented and which also can withstand a pressure even in a division structure.

The manufacturing apparatus 1 of the all-solid-state battery cell 23 described above includes: a restraint instrument 18 that restrains the electrode guide 11 from an outer circumferential side.

According to this configuration, by restraining the electrode guide 11 in the division structure using the restraint instrument 18 and performing pressing in this state, it is possible to withstand an internal pressure due to the pressing.

Further, the configuration of the embodiment described above is a manufacturing method of an all-solid-state battery cell 23 using a press machine, wherein an electrode guide 11 having a cylindrical shape and covering a sample 21 and a cover material 16 that is arranged between the electrode guide 11 and the sample 21, is attachable to and detachable from the electrode guide 11, and has a cylindrical shape are provided, and the sample 21 is poured along the cover material 16.

According to this configuration, by pouring the sample 21 along the cover material 16, even if the powder of the sample 21 is in a temporary shape in a sol, the sample 21 is guided by the cover material 16, and it is possible to easily introduce the sample 21 to a lamination position.

In the manufacturing method of the all-solid-state battery cell 23 described above, after the pressing is completed, at least one of both end portions of the cover material 16 may be bonded and be sealed by a heat sealer.

According to this configuration, by bonding and sealing the end portion of the cover material 16, the sample 21 after the pressing can be taken out of the glove box without being exposed to the atmosphere.

In the manufacturing method of the all-solid-state battery cell 23 described above, after the pressing is completed, at least one of both end portions of the cover material 16 may be adhered and be sealed by an epoxy resin.

According to this configuration, by bonding and sealing the end portion of the cover material 16, the sample 21 after the pressing can be taken out of the glove box without being exposed to the atmosphere.

In the manufacturing method of the all-solid-state battery cell 23 described above, specific information of the sample 21 may be described on a surface of the cover material 16.

According to this configuration, by writing the specific information or the like of the sample 21 on the information description portion, a set mistake is prevented, and it is possible to easily specify the sample 21.

In the manufacturing method of the all-solid-state battery cell 23 described above, a paint through which an X-ray transmits is used for describing the specific information.

According to this configuration, by using a material through which the X-ray transmits for the description on the cover material 16, it is possible to prevent the information described on the cover material 16 from impacting on the X-ray examination.

In the manufacturing method of the all-solid-state battery cell 23 described above, the short axis power collection block 3 and the long axis power collection block 7 that are fixed to a movable side and a fixation side of a press machine, respectively, are provided, the short axis power collection block 3 and the long axis power collection block 7 includes the short axis protrusion portion 5 and the long axis protrusion portion 9, respectively, that are inserted from an end portion of the cover material 16 to the inside, the short axis protrusion portion 5 is shorter than the long axis protrusion portion 9, the short axis protrusion portion 5 is inserted from one end side into the cover material 16, the electrode guide 11 is arranged on a circumference of the cover material 16, the sample 21 is introduced onto a front end of the short axis protrusion portion 5 in the cover material 16, then the long axis protrusion portion 9 is inserted from another end side into the cover material 16, and pressing of the sample 21 is performed.

According to this configuration, by pressing the sample 21 in the cover material 16 having a cylindrical shape, it is possible to perform the pressing of a laminate body by using the cover material 16.

In the manufacturing method of the all-solid-state battery cell 23 described above, the long axis protrusion portion 9 is removed once, an additional laminate body (the negative electrode 21b) is laminated on the sample 21 after the pressing, then the long axis protrusion portion 9 is inserted again, and the pressing is performed.

According to this configuration, it is possible to perform pressing suitable for the case where an additional laminate body that is weak against a pressure is laminated. It is possible to easily introduce the additional laminate body when performing pressing a plurality of times while changing the pressure.

Further, the configuration of the embodiment described above is a manufacturing method of an all-solid-state battery cell 23 using a press machine, wherein an electrode guide 11 having a cylindrical shape and covering a sample 21 is provided, at least part of the electrode guide 11 in a circumferential direction is caused to be a division body which is a separate body from a remaining portion of the electrode guide 11, pressing to a solid-state battery cell 23 is performed in a plurality of stages, and the division body is attached to and detached from the remaining portion at each time of pressing.

According to this configuration, when performing the pressing in the plurality of stages in order to mold a press body such as a pressure bonding lithium, it is possible to confirm whether the sample 21 is normally laminated by attaching and detaching the division body at each time of pressing, and it is possible to easily form a laminate body having a good quality.

In the manufacturing method of the all-solid-state battery cell 23 described above, a temporary shape is formed by introducing the sample 21 into the electrode guide 11 and applying a pressure, and then, a reference electrode 22 is inserted into the sample 21 having the temporary shape.

According to this configuration, when the pressing is performed once, since it becomes possible to perform a management as a solid to some extent, by forming a solid electrolyte having a temporary shape in which the reference electrode 22 can be easily inserted by weakening a pressing pressure, it is possible to facilitate manufacturing of the all-solid-state battery cell 23.

In the manufacturing method of the all-solid-state battery cell 23 described above, the sample 21 is covered by a cover material 16 made of a polyimide film at an inside of the electrode guide 11.

According to this configuration, it is possible to prevent another material from mixing at the inside of the electrode guide 11. The cover material 16 can be formed of a material such as Kapton (registered trademark) which is generally distributed.

In the manufacturing method of the all-solid-state battery cell 23 described above, the cover material 16 made of the polyimide film is peeled off by cutting, and a press body of the sample 21 is exposed.

According to this configuration, it is possible to simply expose and confirm the press body of the sample 21 and easily insert the reference electrode 22.

In the manufacturing method of the all-solid-state battery cell 23 described above, the sample 21 introduced into the cover material 16 is pressed in an axis direction in a state where the division body 113 and the remaining portion 112 of the electrode guide 11 are restrained from an outer circumferential side.

According to this configuration, by pressing the sample 21 in the cover material 16 in the state where the electrode guide 11 in the division structure is restrained, it is possible to press the sample 21 while withstanding an internal pressure due to the pressing.

The configuration of the embodiment described above is an example of the present invention, and various changes can be made without departing from the scope of the present invention such as replacing the components of the embodiment with well-known components.

What is claimed is:

1. An all-solid-state battery cell manufacturing apparatus using a press machine, comprising:
an electrode guide having a cylindrical shape and covering a sample,
wherein at least part of the electrode guide in a circumferential direction is a division body which is a separate body from a remaining portion of the electrode guide, and
the division body is attachable to and detachable from the remaining portion before and after pressing.

2. The all-solid-state battery cell manufacturing apparatus according to claim 1,
wherein a joint portion between the division body and the remaining portion is an irregularity fit portion having an irregularity that is fitted to each other.

3. The all-solid-state battery cell manufacturing apparatus according to claim 1,
wherein in the electrode guide, a range of less than a half circumference in the circumferential direction from which a press body of the sample is capable of being removed is the division body.

4. The all-solid-state battery cell manufacturing apparatus according to claim 3,
wherein the remaining portion excluding the division body in the electrode guide forms an open portion having an opening width that is equal to or larger than a diameter of the press body.

5. The all-solid-state battery cell manufacturing apparatus according to claim 1,
wherein the electrode guide is formed of zirconia.

6. The all-solid-state battery cell manufacturing apparatus according to claim 1, comprising:
a restraint instrument that restrains the electrode guide from an outer circumferential side.

7. An all-solid-state battery cell manufacturing method using a press machine, comprising:
providing an electrode guide having a cylindrical shape and covering a sample:
causing at least part of the electrode guide in a circumferential direction to be a division body which is a separate body from a remaining portion of the electrode guide;
performing pressing to a solid-state battery cell in a plurality of stages; and
attaching and detaching the division body to and from the remaining portion at each time of pressing.

8. The all-solid-state battery cell manufacturing method according to claim 7, comprising:
forming a temporary shape by introducing the sample into the electrode guide and applying a pressure; and
then inserting a reference electrode into the sample having the temporary shape.

9. The all-solid-state battery cell manufacturing method according to claim 7, comprising:
covering the sample by a cover material made of a polyimide film at an inside of the electrode guide.

10. The all-solid-state battery cell manufacturing method according to claim 9, comprising:
peeling off the cover material made of the polyimide film by cutting; and
exposing a press body.

11. The all-solid-state battery cell manufacturing method according to claim 9, comprising:
pressing the sample introduced into the cover material in an axis direction in a state where the division body and the remaining portion of the electrode guide are restrained from an outer circumferential side.
